(19) United States
(12) Patent Application Publication
(10) Pub. No.: US 2025/0207280 A1
(43) Pub. Date: Jun. 26, 2025

(54) ELECTROLYTE REGENERATION

(71) Applicant: ENAPTER S.R.L., Crespina Lorenzana (IT)

(72) Inventors: Antonio FILPI, Crespina Lorenzana (IT); Gabriele AGONIGI, Crespina Lorenzana (IT); Vito PINTO, Crespina Lorenzana (IT); Alessandro CAPPELLETTI, Crespina Lorenzana (IT); Carlo MARESCA VON BECK, Crespina Lorenzana (IT); Anita SCIGLIANO, Crespina Lorenzana (IT); Gaia NERI, Crespina Lorenzana (IT); Jan-Justus SCHMIDT, Crespina Lorenzana (IT); Lazarus DIAMOND, Crespina Lorenzana (IT)

(21) Appl. No.: 18/844,383

(22) PCT Filed: Mar. 7, 2023
(86) PCT No.: PCT/EP2023/055812

§ 371 Date: Sep. 5, 2024

(30) Foreign Application Priority Data
Mar. 7, 2022 (GB) 2203111.6

(51) Int. Cl. C25B 15/08; C25B 15/021; C25B 15/027; C25B 15/031; C25B 15/033

(52) U.S. Cl. CPC C25B 15/087; C25B 15/021; C25B 15/027; C25B 15/031; C25B 15/033; C25B 15/085

(57) ABSTRACT

A system for regenerating electrolyte from an electrochemical cell comprises: a directing means for receiving electrolyte from an electrochemical cell, the directing means having a first outlet and a second outlet; a sensor or sample port positioned between the electrochemical cell and the first and second outlets via which the presence of a contaminant in the electrolyte may be measured; and a purification stage for receiving electrolyte from the second outlet and producing regenerated electrolyte, the purification stage comprising an ion exchange chamber. When a contaminant is detected, the directing means directs at least a portion of the electrolyte through the second outlet to the purification stage. The system is particularly suitable for use with an AEM electrolyser.

### FIELD OF THE INVENTION

The present invention relates to an improved means and method for regenerating electrolyte from an electrochemical cell, in particular to regenerating electrolyte that may be used in electrolysers such as AEM electrolysers.

### BACKGROUND TO THE INVENTION

Hydrogen has a multitude of applications, ranging from energy storage to the production of fertilisers. Hydrogen can be derived from many sources. Some of these sources, such as fossil fuels, are undesirable for obvious reasons. Therefore, there is a need to be able to produce hydrogen in a reliable and sustainable manner.

Electrochemical cells are devices which produce electrical energy from chemical reactions or, conversely, which use electrical energy to cause chemical reactions. An example of an electrochemical cell is the electrolyser.

Electrolysers are devices used for the generation of hydrogen and oxygen by splitting water. It is possible to power such devices with excess renewable energy, using hydrogen as a means for energy storage as opposed to batteries, for example. Electrolysers generally fall in one of three main technologies currently available, namely anion exchange membrane (AEM), proton exchange membrane (PEM), and liquid alkaline systems. Liquid alkaline systems are the most established technology, with PEM being somewhat established. AEM electrolysers are a relatively new technology. Other technologies, such as solid oxide electrolysis are available.

AEM and PEM electrolysers are reliant on the transfer of ions from one half-cell to the other for the generation of hydrogen. AEM systems rely on the movement of hydroxide ions, OH⁻, whilst PEM systems rely on the movement of hydrogen ions, H⁺. In order to let the ions pass through the membrane electrode assembly that separates the two half-cells, either a solid (ionomer) or liquid electrolyte is required.

PEM systems usually comprise an ionomer as their electrolyte. The water that is used in such systems is required to be of extremely high purity and therefore has almost no buffering capacity towards contaminants such as foreign ions.

For AEM systems, ionomer development is not yet as mature as for PEM systems, thus a liquid electrolyte is usually preferred. This alkaline electrolyte allows water with a lower purity to be used, having a somewhat buffering effect towards contamination. Nevertheless, accumulation of contaminants beyond the electrolyte's buffering capacity can affect electrolyser efficiency; these effects can be either reversible or irreversible, depending on the amount and nature of the contaminants. The contaminants, introduced by whatever mechanism, may accumulate and be circulated until they are filtered, flushed or replaced.

The presence of acidic species from the atmosphere or from feed water, such as carbon dioxide, bicarbonates, calcium etc. may alter the pH of the electrolyte. There is a threshold below which, in AEM systems, it has been found that a drop in electrolyte pH of 1 can reduce efficacy by up to 60 mV/cell in a stack. Moreover, even the accumulation of contaminant anions that may not change the electrolyte pH, such as sulfates, can result in competition with the hydroxyl ions in the membrane. This may lead to an effect well known in PEM electrolysis/fuel cells, where foreign cations generate a pH gradient between the anode and cathode, further reducing the efficiency of the system. Lastly, the contaminants may directly poison the electrocatalysts.

At present the approach to counter this is the replacement of the electrolyte. This is costly, requires labour and downtime of the system. Thus, there remains a need for improved systems and methods for removing contaminated electrolyte from electrochemical cells, and in particular from AEM electrolysers.

### SUMMARY OF THE INVENTION

An object of the present invention is to provide a system and method for regenerating electrolyte from an electrochemical cell, such as an AEM electrolyser, so that the electrolyte may be reused, for instance in the electrochemical cell from which it originated.

Thus, the present invention provides a system for regenerating electrolyte from an electrochemical cell, said system comprising:
a directing means for receiving electrolyte from an electrochemical cell, the directing means having a first outlet and a second outlet;
a sensor or sample port positioned between the electrochemical cell and the first and second outlets via which the presence of a contaminant in the electrolyte may be measured; and
a purification stage for receiving electrolyte from the second outlet and producing regenerated electrolyte, the purification stage comprising an ion exchange chamber;
wherein, when a contaminant is detected, the directing means directs at least a portion of the electrolyte through the second outlet to the purification stage.

Also provided is a method for regenerating an electrolyte from an electrochemical cell, said method comprising:
passing the electrolyte from an electrochemical cell to a directing means, the directing means having a first outlet and a second outlet,
measuring the presence of a contaminant in the electrolyte, preferably via a sensor or sample port, between the electrochemical cell and the first and second outlets;
when a contaminant is detected, directing at least a portion of the electrolyte through the second outlet of the directing means to a purification stage; and
purifying the electrolyte from the second outlet in the purification stage to produce regenerated electrolyte, the purification stage comprising an ion exchange chamber.

### DETAILED DESCRIPTION OF THE INVENTION

The present invention provides a system and method for regenerating electrolyte from an electrochemical cell.

In some embodiments, the electrochemical cell does not form part of the system of the present invention. In these embodiments, the system may be used as a temporary or permanent add-on for installation with existing electrochemical cells. However, in preferred embodiments, the electrochemical cell forms part of the system of the present invention.

A wide range of electrochemical cells are suitable for use in the present invention, including electrolysers, fuel cells, electrochemical compressors and batteries (e.g. zinc-air, silver oxide or lead-acid batteries). Preferably, the electrochemical cell is an electrolyser, i.e. an electrochemical cell in which electricity is used to convert water into hydrogen and oxygen.

The electrolyser may be an anion exchange membrane (AEM) electrolyser, a proton exchange membrane (PEM) electrolyser, or a liquid alkaline electrolyser. In a preferred embodiment, the electrochemical cell is an AEM electrolyser, and more preferably an AEM electrolyser operating with a substantially dry cathode.

AEM electrolysers contain two half-cells separated by the anion exchange membrane, each half-cell containing an electrode. In use, water enters the electrolyser in one of the half cells, and is converted at the cathode into hydrogen and hydroxide ions. The hydroxide ions pass through the anion exchange membrane and react at the anode to form water and oxygen. Thus, the electrochemical reactions that take place in an AEM electrolyser may be represented as follows:

Cathode half-cell: 4H₂O+4e⁻→2H₂+4OH⁻

Anode half-cell: 4OH⁻→O₂+4e⁻+2H₂O

Overall: 4H₂O→2H₂+O₂+2H₂O

Hydrogen gas will typically leave the electrolyser via the cathode half-cell and oxygen will typically leave the electrolyser via the anode half-cell. In preferred embodiments, water is introduced and leaves the AEM electrolyser via the anode half-cell as part of a liquid electrolyte. This allows the cathode half-cell, and therefore the hydrogen produced therein, to remain substantially dry.

In some embodiments, the electrolyte that is regenerated according to the system and method of the present invention is from a plurality of electrochemical cells, referred to herein as a stack of cells or a stack. It will be appreciated that, where reference to an electrochemical cell is made herein, this may alternatively be a reference to a stack of cells.

Where the electrolyte is from a stack of electrochemical cells, a combination of different electrochemical cell types may be present, for instance an electrolyser and one or more compressors. Generally, however, the electrochemical cells in a stack will be of the same type and are preferably electrolysers, and more preferably AEM electrolysers.

These cells in a stack may be operated in series, but they may also be operated in parallel. For instance, hydrogen, electrolyte and/or electricity may flow through the stack in series, i.e. from or via a first cell in the stack to a second cell in the stack, and so on. Where the cells in a stack are operated in parallel, hydrogen, electrolyte and/or electricity may be supplied to multiple cells in a stack from the same upstream source and preferably exit the cells to the same downstream source. It will be appreciated that in some instances, hydrogen will be generated in the cells and, as such, there will not be a source to the cells of hydrogen.

As an example of operation in series, where the stack contains more than one AEM electrolyser, the water that is produced in the half-cell of a first AEM electrolyser may be used as, at least part of, the liquid electrolyte feed to the half-cell in a second AEM electrolyser. In some embodiments, the half-cell of each of the AEM electrolysers in a stack, except the first electrolyser, may receive liquid electrolyte water from the half-cell of the previous electrolyser. In these embodiments, there may be just one stream of liquid electrolyte that flows through the AEM stack in series.

In other embodiments, multiple streams of liquid electrolyte may flow through the AEM stack in parallel. In other words, the electrolyte from one AEM electrolyser is not used as the feed for another AEM electrolyser in the stack, but rather each AEM electrolyser has its own stream of electrolyte. In some embodiments, each stream of electrolyte that exits an AEM electrolyser in a stack is preferably combined into a single output stream. Each stream of electrolyte to an AEM electrolyser in a stack may split from a single feed stream.

As an example of operation in series, where the stack contains more than one AEM electrolyser, the hydrogen that is produced in the half-cell of a first AEM electrolyser may be passed, at least in part, to the half-cell of a second AEM electrolyser preferably acting as a compressor, such that the hydrogen exiting from the second AEM electrolyser comprises hydrogen produced by the first AEM electrolyser. In some embodiments, the half-cell of each of the AEM electrolysers in a stack, except the first electrolyser, may receive hydrogen from the half-cell of the previous electrolyser. In these embodiments, there may be just one stream of hydrogen that flows through the AEM electrolyser stack in series. However, it is often the case that the hydrogen produced by the half-cells in a stack of AEM electrolysers is not passed to the half-cell of another AEM electrolyser in the stack, but rather the hydrogen is taken as a product from each half-cell of a stack.

Although operation is series and parallel is illustrated above in connection with AEM electrolysers, it will be appreciated that the same principles apply to stacks of other types of electrochemical cell.

The nature of the electrolyte will, to a certain extent, depend on the type of electrochemical cell in which it is used. Typically, the electrolyte will be an aqueous liquid electrolyte, i. e. it will contain water. The electrolyte may comprise water in an amount of at least 90% by weight.

The electrolyte may contain one or more contaminants, i.e. unwanted components. The system and method of the present invention is intended to remove such contaminants from the electrolyte. For instance, the electrolyte may contain one or more contaminants selected from acidic species such as carbon dioxide, bicarbonates, calcium and sulfates. Carbon dioxide may be a particularly problematic contaminant so, in preferred embodiments, this contaminant is preferably removed in the purification stage. As discussed below, carbon dioxide is typically present in dissolved forms in the electrolyte, e.g. as CO_{2(aq)} and H₂CO_{3(aq)}.

Further components, i.e. that are not contaminants, may also be present in the electrolyte. For instance, the electrolyte may contain an ionic compound, which is preferably a salt. The salt may be a hydroxide salt, a halide salt such as a chloride salt, a sulfate salt, a carbonate salt or a sulfamate. The ionic compound may be selected from KOH, NaOH, LiOH, NaCl, KCl, LiCl, H₂SO₄, K₂CO₃, Na₂SO₄, NiSO₄ and Ni (NH₂SO₃)₂. Although combinations of ionic compounds are envisaged, a single ionic compound is typically used. The ionic compound will typically be used in the electrolyte in an amount of less than 50% by weight (i.e. % w/w). For instance, the ionic compound may be used in an amount of from 0.01 to 30%, preferably from 0.05 to 10% and more preferably from 0.1 to 5% by weight. The concentration of the ionic compound in the electrolyte is preferably 1% by weight.

In preferred embodiments, the electrolyte comprises a metal hydroxide, such as potassium hydroxide, in an amount of at least 0.5% by weight, e.g. 0.5 to 1.5% by weight. Metal hydroxides are often used in electrolytes in electrochemical cells, and particularly in AEM electrolysers.

Though less preferred, in some embodiments, no further components (i.e. components other than contaminants) are present in the electrolyte. In these embodiments, the electrolyte may be substantially pure water. It will be appreciated that the substantially pure water may contain contaminants but that these may be removed during the regeneration process of the present invention.

According to the present invention, the electrolyte is passed to a directing means situated downstream of the electrochemical cell. During operation, the directing means may receive only a portion of the total electrolyte within the (or each) upstream electrochemical cell. However, it is generally preferred that all of the electrolyte is passed to the directing means.

The directing means may take a number of different forms provided the directing means comprises a first outlet and a second outlet. For instance, the directing means may comprise a junction, e.g. a junction in a pipe through which the electrolyte flows, and a switch which directs the electrolyte through a first outlet or a second outlet at the junction. The junction may be a T-junction, or a Y-junction, or any other junction which is suitable for directing a stream of electrolyte through a first or second outlet.

In an alternative embodiment, the directing means may comprise a tank in which the electrolyte is held, where the tank comprises a first outlet and a second outlet. It will be appreciated that a tank may be any form of reservoir with a wide range of shapes. Typical tanks will be cylindrical or cuboid.

In still a further embodiment, the directing means may comprise a tank in which the electrolyte is held and, downstream of the tank, a junction and a switch which directs the electrolyte through a first outlet or a second outlet at the junction. The junction and switch may be as described above.

In some embodiments, multiple streams of electrolyte are regenerated, for instance in embodiments described above where electrolyte flows through a stack of electrochemical cells in parallel. In these instances, the multiple streams are preferably combined before they are passed through the first or second outlet of the directing means.

Where the directing means comprises a tank, the multiple streams may be combined in the tank. To ensure that the streams are well-mixed, the electrolyte in the tank may be stirred or otherwise agitated. Alternatively or additionally, where the directing means comprises a junction downstream of the tank, a mixing valve may be present between the tank and the first and second outlets.

Alternatively, the streams may be combined at a convergence point in a pipe, such as a manifold. To ensure that the streams are well-mixed, a mixing valve may be present between the convergence point and the first and second outlets of the directing means. However, where the directing means comprises a tank, mixing may take place in the directing means and, as such, a mixing valve between the convergence point and the first and second outlets of the directing means may not be required.

According to the present invention, the presence of a contaminant in the electrolyte is measured between the electrochemical cell and the first and second outlets of the directing means. As will be explained in further detail below, when a contaminant is detected, the directing means directs at least a portion of the electrolyte through the second outlet to a purification stage.

Preferably, the presence of a contaminant is measured via a sensor or sample port. The sensor or sample port may be positioned anywhere between the electrochemical cell and the first and second outlets of the directing means. For instance, the sensor or sample port may be positioned at a junction in a pipe where the electrolyte is directed through the first or second outlet. Alternatively or additionally, where the directing means comprises a tank, the sensor or sample port may be positioned on the tank. The sensor or sample port may also be positioned downstream of the tank but before the first and second outlet of the directing means or, though less preferred, even upstream of the tank. Multiple sensors or sample ports may be used.

Where multiple streams of electrolyte are regenerated, a sensor or sample port may be provided for each of the multiple streams before they are combined. However, it is generally preferred that the presence of contaminants is measured via a sensor or sample port once the multiple streams have been combined, and more preferably once the multiple streams have been subjected to mixing, e.g. in a tank or via a mixing valve.

A sensor may be immersed in the electrolyte continuously or temporarily, but is preferably immersed continuously. In contrast, where measurements are taken via a sample port, samples of electrolyte are preferably withdrawn intermittently then tested with a sensor.

Suitable sensors—for measuring the presence of contaminants in the electrolyte directly or in a sample that has been withdrawn through a sample port—include pH sensors and conductivity sensors. However, it has been found that pH degradation remains substantially stable and then undergoes a rapid change, e.g. in AEM systems from approximately pH 13, only once the electrolyte is close to complete degradation. Conductivity on the other hand changes at a steadier pace, allowing for more accurate information to be gathered with a lower sample frequency. Though less significant, a further benefit of conductivity sensors is that they require less frequent calibration and maintenance than pH sensors. Thus, in preferred embodiments, the sensor is a conductivity sensor.

In some embodiments, it may be useful to use both a pH sensor and a conductivity sensor. This arrangement is believed to better monitor the presence of both neutral and acidic contaminants.

The presence of contaminants in the electrolyte may be measured at regular intervals. For instance, the presence of contaminants could be measured at least once a week, but preferably less than once a day. These time periods are particularly suitable when conductivity is measured. Where the pH of the electrolyte is measured, the presence of contaminants in the electrolyte may be measured more regularly, for instance at least once a day, such as at least twice a day, or more regularly such as at least hourly. In some instances, pH may be measured more regularly than conductivity. This is because changes in pH tend to be sudden once the electrolyte is relatively close to degradation, whereas conductivity changes at a steadier pace allowing monitoring to take place with larger intervals. However, in practice, conductivity may be measured regularly, for instance at least one a day, such as at least twice a day.

It is envisaged that either sensor type may be automated, controlled by a computing means, or be done manually with samples being taken for analysis. Generally, control of the sensors will be automated, preferably with a manual override.

In view of the potential presence of both acidic and neutral contaminants it is envisaged that a combination of pH and conductivity sensors may be used. Conductivity may actually improve with the addition of neutral contaminants. Therefore, in some embodiments the sensor comprises at least one of, and preferably both, a pH sensor and a conductivity sensor.

As mentioned above, when a contaminant is detected, at least a portion, and preferably all, of the electrolyte is directed through the second outlet to a purification stage. It will be appreciated that a contaminant will only be deemed “detected” once it has reached a threshold level, i.e. a level at which it is deemed problematic. For instance, with an AEM electrolyser that uses an electrolyte containing 0.5 to 1.5% by weight, e.g. 1% by weight, potassium hydroxide, a pH level of lower than 11.5 and/or a conductivity of lower than 30 μs/cm may be deemed problematic.

Where the presence of contaminants is not detected, i.e. their level is below the threshold level, at least a portion, and preferably all, of the electrolyte is directed through the first outlet. Preferably, the electrolyte that passes through the first outlet is recycled to the electrochemical cell from which it originated. In less preferred embodiments, the electrolyte may be directed to a different electrochemical cell or another non-electrochemical system.

Where contaminants are not detected, the directing means may still direct at least a portion of the electrolyte through the second outlet to the purification stage to ensure that the electrolyte remains clean. Similarly, where contaminants are detected, the directing means may still direct at least a portion of the electrolyte through the first outlet, for instance for recycle to the electrochemical cell, where only moderate regeneration of electrolyte is required. However, both of these options are less preferred and the electrolyte will generally be passed, at any one time, either through the first or second outlet of the directing means.

The purification stage receives electrolyte from the second outlet of the directing means and produces a regenerated electrolyte.

Preferably, the electrolyte is not subjected to any processing which may significantly change its composition between the second outlet of the directing means and the purification stage, and preferably between the electrolyser and the purification stage. It will be appreciated the electrolyte may be pumped at various points to ensure its flow around the system of the present invention, as well as held and/or mixed (e.g. in a tank which forms part of the directing means).

A regenerated electrolyte contains a reduced level of contaminants as compared to the electrolyte that is received from the electrochemical cell.

Preferably, the regeneration of electrolyte is isotonic. This means that the regenerated electrolyte that leaves the purification stage has the same osmotic pressure as the electrolyte that enters the purification stage. In other words, the sum of concentration of each ionic species multiplied by their charge is not changed. This is notably different from systems in which water is purified since, in these systems, contaminants are removed or exchanged for water (i.e. a non-ionic species), rather than being exchanged for different ions.

Where the electrolyte passed to the electrochemical cell contains an ionic compound (i.e. a non-contaminant ionic compound), the regenerated electrolyte will preferably contain the same ionic compound as present in the electrolyte passed to the electrochemical cell. For instance, an electrolyte containing a metal hydroxide in an amount of from 0.5% to 1.5% by weight may be passed to the electrochemical cell. As discussed above, contaminants may accumulate in the electrolyte during operation, such that the contaminated electrolyte entering the purification stage comprises, for example, metal carbonates. Following removal of the contaminants, the regenerated electrolyte preferably contains the same metal hydroxide in the same amount as that present in the electrolyte originally passed to the electrochemical cell.

Though less preferred, it is also envisaged that the regenerated electrolyte may contain different ionic compounds to those present in the electrolyte provided to the electrochemical cell. This may allow e.g. an electrolyte which is easy to handle to be first introduced into the cell, but the cell to largely operate using a different electrolyte which is less easy to handle. It will be understood that ‘different ionic compounds’ does not refer to the contaminants, rather to ionic compounds introduced, e.g. via ion-exchange, during the purification stage.

A reduction in contaminants and/or isotonic regeneration may be achieved by virtue of an ion exchange chamber that forms part of the purification stage.

The ion exchange chamber may comprise any combination of materials suitable for trapping and/or exchanging contaminants. Suitable materials include ion exchange resins (which, in some embodiments, may be in the form of a gel) and membranes, and zeolites. Preferably, the ion exchange chamber used in the present invention comprises a cation exchange resin or an anion exchange resin. The ion exchange chamber may also comprise a mixture of cation and anion exchange resins, i.e. it may comprise a mixed bed of cation and anion exchange resins.

Ion exchange resins are a family of resins with different capturing and exchange capabilities. As mentioned, the electrolyte entering the ion exchange chamber may comprise ionic compounds that were present in the electrolyte originally passed to the electrochemical cell and contaminants, such as contaminant cations and/or contaminant anions. In a cation exchange resin, it is preferred that contaminant cations are exchanged for cations which correspond to cations present in the electrolyte originally passed to the electrochemical cell. Suitable cations for which contaminant cations may be exchanged include those present in the ionic compounds described above. For instance, where the electrolyte comprises a potassium salt, contaminant cations are preferably exchanged for K⁺.

Similarly, in an anion exchange resin, it is preferred that contaminant anions are exchanged for anions which correspond to anions present in the electrolyte originally passed to the electrochemical cell. Suitable anions for which contaminant anions may be exchanged include those present in the ionic compounds described above. For instance, where the electrolyte comprises a hydroxide salt, contaminant anions are preferably exchanged for a hydroxide, OH⁻.

The electrolyte that leaves an ion exchange chamber is preferably isotonic with the electrolyte which enters the ion exchange chamber, i.e. their osmotic pressures are the same. For example, where the electrolyte contains contaminant anions such as carbonate (CO₃²⁻), the anion exchange resin may exchange each carbonate anion for two hydroxide anions.

Where the purification system is being used for the deionisation of water (an option which is discussed in more detail below), a cation exchange resin may exchange contaminant cations for protons, H⁺, and an anion exchange resin may exchange contaminant anions for hydroxide, OH⁻. This process, however, does not result in isotonic solutions since the protons and hydroxide ions exchanged into the solution recombine to form water, resulting in a reduced osmotic pressure.

Thus, in a cation exchange resin, contaminant cations in the electrolyte may be swapped for a proton, H⁺, or preferably another cation which is suitable for electrolyte regeneration such as K⁺. In an anion exchange resin, contaminant anions in the electrolyte are preferably swapped for a hydroxide, OH⁻.

Ion exchange resins maybe strong or weak. The selection of an appropriate resin depends on the starting electrolyte (or water for deionisation) and the desired quality of product.

Ion exchange resins capture ions by ion exchange and large neutral particles by mechanical filtering. Generally, small neutral particles are not captured by ion exchange resins directly, but are rather transformed by the resin into ions which can be trapped. For example, CO₂ gas—or more specifically, its dissolved forms CO_{2(aq)} and H₂CO_{3(aq)}—can react with the hydroxides in the resin to form HCO₃⁻ and CO₃²⁻ which are then trapped.

The cation exchange resin that may be present in a cation exchange chamber (or indeed a mixed bed chamber) may be any suitable structure like polyAMPS or polystyrene sulfonate. The cation that is present in the resin for exchange with unwanted cationic contaminants in the electrolyte may be any suitable positively charged ion such as a H⁺ or a metal cation, such as K⁺, that is the same as that used in the metal hydroxide that is preferably present in the electrolyte. Preferably, the cation that is present in the resin for exchange with unwanted cationic contaminants in the electrolyte is K⁺. Where a water for deionisation is passed through a cation exchange resin, an option that is discussed in more detail below, then the cation that is present in the resin for exchange with unwanted cations in the water is preferably H⁺. The presence of the appropriate counterion in the cation exchange resin can be controlled by using a concentrated solution containing the appropriate counterion during the regeneration of the resin.

For the anion exchange chamber (or indeed a mixed bed chamber), the counter ion in the anion exchange resin is any suitable negatively charged ion but is preferably OH⁻. Hydroxide ions are appropriate whether electrolyte or water to be deionised is being treated by the anion exchange resin. The anion exchange resin may comprise any suitable material such as styrene-divinylbenzene copolymers charged with quaternary ammonium cations. Other anion exchange resin may also be used.

Although the present invention may be carried out using just a single ion exchange chamber, the purification stage preferably comprises two ion exchange chambers. In some instances, more than two chambers may be used. It will be appreciated that each of the ion exchange chambers that is present in the purification stage is preferably as described above.

In such embodiments, it is preferred that the chambers are arranged in series, such that the electrolyte leaving an upstream chamber may then enter a further chamber downstream. For instance, in purification stages comprising a first and second ion exchange chamber, the chambers may be arranged such that the electrolyte passes through the first ion exchange chamber and then the second ion exchange chamber. A bypass mechanism may also be present which allows the electrolyte to pass through only one of the first and second ion exchange resins. Where a bypass mechanism is provided, the ion exchange chamber or chambers to which the electrolyte is directed is determined based on the contaminant or contaminants that are detected via the sensor or sample port. For instance, should a lack of cationic contaminants be detected, then the electrolyte may bypass the ion exchange chambers comprising cation exchange resin.

Another possibility, although less preferred, is that the first and second ion exchange chambers are arranged in parallel, such that the electrolyte may pass through only one of the first and second chambers.

Where two (or more) ion exchange chambers are present, it is preferred that one of the two ion exchange chambers is a cation exchange chamber, and the other of the two ion exchange chambers is an anion exchange chamber. In preferred embodiments, the cation and anion exchange chambers are arranged in series, and more preferably the electrolyte is passed through a cation exchange chamber and subsequently through an anion exchange chamber. The arrangement of the cation exchange chamber upstream of the anion exchange chamber mitigates the risk of precipitation in the electrolyte. Precipitates could potentially foul an electrochemical cell or other components to which the regenerated electrolyte is passed.

Regardless of the order in which the ion exchange chambers are provided, it is envisaged that a filter may be provided. The filter is preferably position downstream of the purification stage. The filter ensures that any precipitate does not enter the wider system. Where the regenerated electrolyte is recycled (as is discussed in greater detail below) to an electrochemical cell, the filter is preferably positioned upstream of the electrochemical cell. The filter is preferably changeable. In some embodiments, a second filter may be added to the system before the first filter is removed to ensure that there is no system downtime.

An ion exchange chamber, in accordance with the present invention, may comprise two or more sub-chambers, such as three sub-chambers. Such an arrangement can minimise downtime of the system. Preferably, these sub-chambers are arranged in parallel. Preferably, at any one time, at least one of the sub-chambers is used for regenerating the electrolyte. The presence of a second sub-chamber allows simultaneous regeneration of electrolyte in a first sub-chamber, and regeneration of the ion-exchange material or deionisation of water in a second sub-chamber. A third sub-chamber also allows for simultaneous regeneration of electrolyte in a first sub-chamber, regeneration of the ion-exchange material in a second sub-chamber and deionisation of water in a third sub-chamber. The deionisation of water is discussed in more detail below.

In systems comprising multiple ion exchange chambers, such as a first and a second ion exchange chamber, each chamber is preferably as described above and, as such, preferably comprises two or more sub-chambers, such as three sub-chambers, which may be arranged in parallel. In such instances, the sub-chambers of the first and second ion exchange chambers may be connected such that the electrolyte exiting a sub-chamber of the first ion exchange chamber may be received by any of the sub-chambers in the second ion exchange chamber.

An ion exchange chamber may be regenerated by passing a regeneration fluid through the chamber. This allows the chambers to be regenerated in-situ. For instance, to regenerate a cation exchange chamber, the chamber may be flushed with an acid such as hydrochloric acid where H⁺ is the desired cation to be exchanged with unwanted contaminants (such as for the purification of water), or a metal halide such as potassium chloride or sodium chloride where a metal cation is the desired cation to be exchanged with unwanted contaminants (such as for the purification of electrolyte). To regenerate an anion exchange chamber, the chamber may be flushed with a base, and preferably a metal hydroxide such as potassium hydroxide or sodium hydroxide.

Regeneration of ion exchange resins is normally an exothermic process. However, ion exchange resins are known to become less effective at certain temperatures. Thus, the regeneration stage of the present invention may comprise means for temperature regulation.

Where a cation exchange resin is used, the purification stage comprises means for maintaining the temperature in the ion exchange chamber at less than 150° C., preferably less than 140° C., and more preferably less than 130° C. Wherein an anion exchange resin is used, the purification stage comprises means for maintaining the temperature in the ion exchange chamber at less than 80° C., preferably less than 70° C., and more preferably less than 60° C. It is envisaged that, in embodiments comprising both cation and anion exchange resins in different ion exchange chambers, means as described above may be provided to maintain each resin within these temperatures.

The means for maintaining the temperature may comprise a heat exchanger. The heat exchanger preferably cools the ion exchange chamber and transfers the heat for use in another part of the system, or a separate system. For instance, in systems comprising an electrolyser, it is envisaged that this heat may be used to increase the temperature of electrolyte being passed into the electrolyser. The means for maintaining the temperature may additionally comprise a temperature sensor for measuring the temperature in the ion exchange chamber. The heat exchanger may then be operated only when cooling is required.

In some embodiments, the regeneration stage of the present invention may be used for the deionisation of water, as well as the regeneration of electrolyte. The water that is deionised may be conventional tap water. The water may be passed through one or more ion exchange chambers, in the same manner described above in connection with the electrolyte.

The water that is being deionised may be treated in further stages, i.e. other than the purification stage. For instance, the water may be further treated in one, and preferably both, of a water softening stage and a reverse osmosis stage. These additional stages are preferably upstream of the purification stage, such that water entering a first ion exchange chamber has already been treated. Alternatively, the water treatment stages may be downstream of all the purification stage or even between ion exchange chambers as part of the purification stage, such that water entering said water treatment stages has already passed through at least one ion exchange chamber.

It is generally preferred that the electrolyte and water to be deionised pass through the same purification stages. However, in some less preferred embodiments, a separate water treatment system may be present. In this instance, said water treatment system may comprise at least one of a water softening stage; a reverse osmosis stage; and an ion exchange stage, wherein the ion exchange stage preferably comprises a first cation exchange chamber and a second anion exchange chamber. Preferred features of the ion exchange stage are as described above in connection with the purification stage.

In preferred embodiments, the deionised water that is produced in the purification stage (and optional further treatment stages) or the separate water treatment system is passed to an electrochemical cell, and preferably to the electrochemical cell from which the electrolyte originated. Where regenerated electrolyte and/or electrolyte from the first outlet of the directing means is also passed to an electrochemical cell, then this may be combined with the deionised water before it enters the electrochemical cell. In such an instance, the addition of deionised water may serve to dilute said regenerated electrolyte and/or electrolyte from the first outlet to a suitable level, depending upon the concentration of the electrolyte. Alternatively, the regenerated electrolyte and/or electrolyte from the first outlet may be introduced into the electrochemical cell via a separate inlet to the deionised water.

Each of the liquids that are passed through an ion exchange chamber—i.e. electrolyte and optionally regeneration fluid and/or water for deionisation—may be introduced into the chamber via separate inlets and leave the chamber via separate outlets.

In an alternative embodiment, an ion exchange chamber may have a single inlet and a single outlet. In these latter embodiments, the single inlet and outlet are multipurpose but, at any one time, only one fluid is entering or exiting the chamber: electrolyte for regeneration, water for deionisation, or regeneration fluid for the ion exchange materials. One or more valves may be used to control the fluid entering and exiting the chamber so that only one fluid is allowed to flow through the ion exchange chamber at any given time. Preferably, when the liquid that is passing through the chamber is changed from a first to a second liquid, a flushing fluid is used between the first and second liquids to limit contamination.

Outlet destinations can be either the next ion exchange resin or another liquid destination such as the electrolyser in the case of the regenerated electrolyte and the water that is being or has been deionised, or waste in the case of regeneration and flushing fluids.

It is envisaged that the valves may be controlled by sensors linked to computing means, said computing means adapted to control the valves, or pre-determined time/flowrate monitoring, especially in the instance of flushing and waste disposal.

In an embodiment of the present invention, where multiple ion exchange chambers are used, the chambers may be combined in one housing or area within the system.

In preferred embodiments, the regenerated electrolyte that leaves the purification stage is recycled to the electrochemical cell from which it originated. In less preferred embodiments, the regenerated electrolyte may be directed to a different electrochemical cell or another non-electrochemical system. In preferred systems and methods of the present invention, both of the electrolyte from the first outlet of the directing means and the regenerated electrolyte is recycled to an electrochemical cell, and preferably the electrochemical cell from which the electrolyte originated.

Pumps, or other suitable means for the circulation of the electrolyte and other fluids around the systems of the present invention are naturally utilised, but not intended to form a limiting part of the present invention.

It will be appreciated that the system of the present invention may be used for carrying out the method of the present invention, but alternatively other methods for which it is suitable.

Similarly, the method of the present invention may be carried out using a system of the present invention, but alternatively other systems which are suitable for this purpose.

To help understanding of the invention, a specific embodiment thereof will now be described by way of example and with reference to the accompanying drawings, in which:

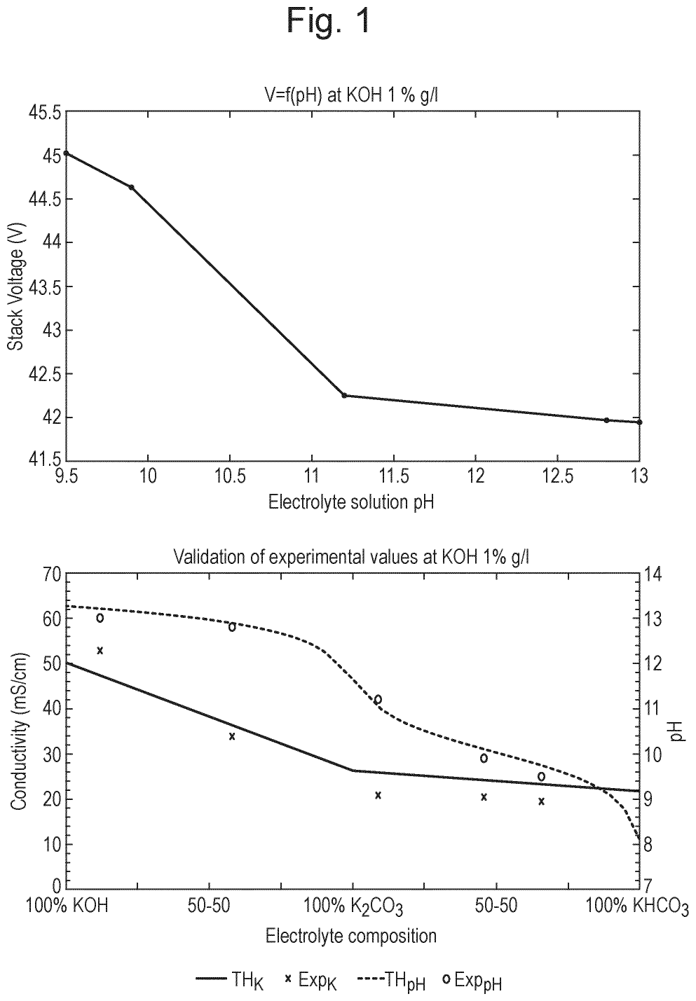

FIG. 1 shows graphs of pH against time and conductivity against time respectively;

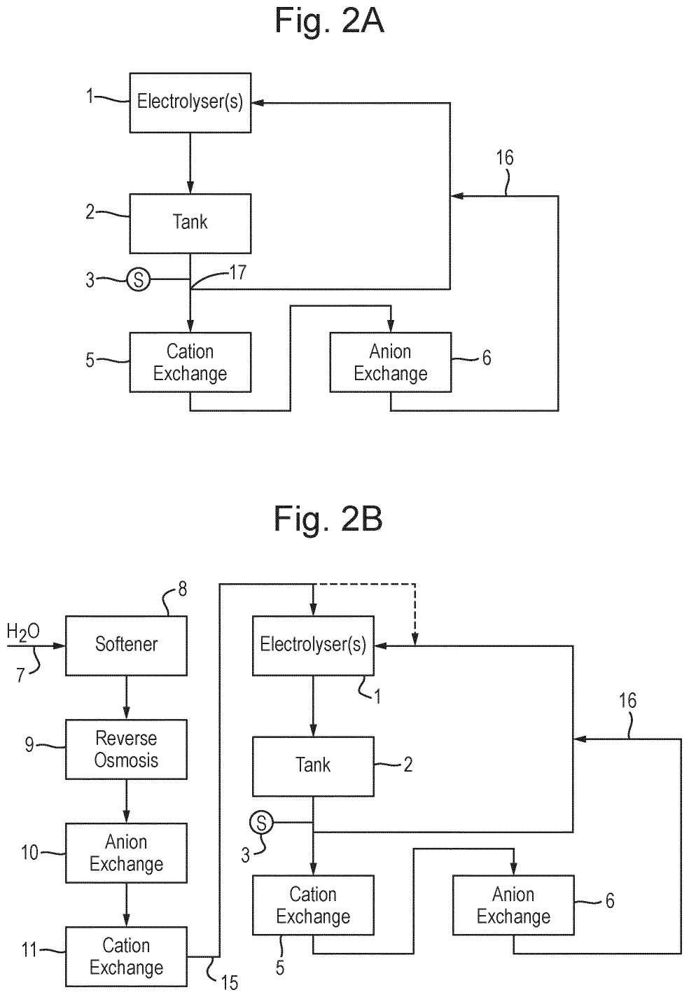

FIGS. 2A and 2B show a schematic of a system in accordance with the present invention, without and with water treatment respectively;

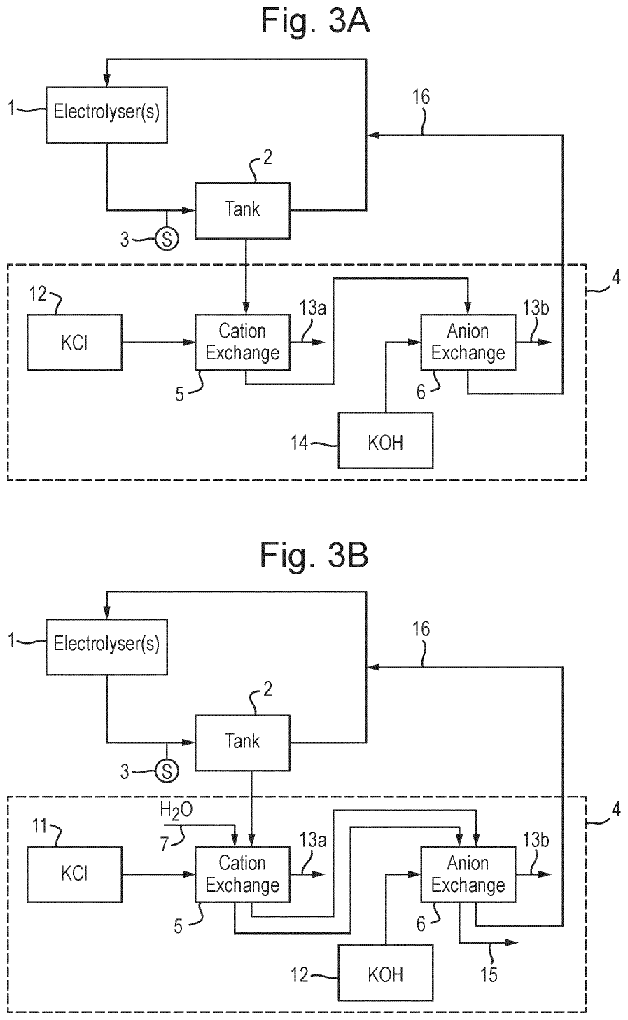

FIGS. 3A and 3B show a schematic of an alternative system in accordance with the present invention, without and with water treatment respectively; and

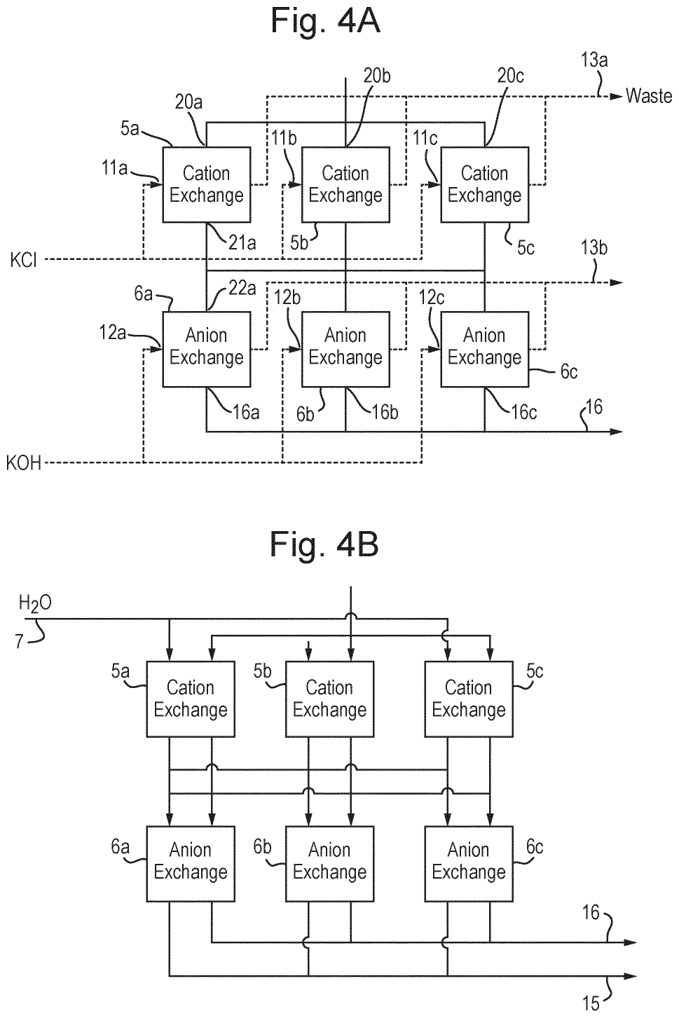

FIGS. 4A and 4B show a purification stage with multiple sub-chambers, without and with water deionisation functionality respectively.

As has been shown in FIG. 1, direct measurement of the electrolyte pH is not as useful a method for monitoring electrolyte degradation and acidic contaminants because a significant drop in pH is only observed once the electrolyte degradation is approaching 100%. On the conductivity scale instead, the change in slope from 0% to 100% electrolyte degradation is very clear, and it is a very helpful parameter to keep track of the electrolyte status. Moreover, the conductivity is strongly dependent on the total alkalinity of the electrolyte solution which means that a further matching of total alkalinity and conductivity could be obtained if the requirements on any deionised input water are respected.

Referring to FIG. 2A, a schematic of a system in accordance with the present invention without water treatment functionality, there can be seen an electrolyser 1 with an outlet for electrolyte to go to tank 2. A conductivity sensor 3 in communication with a computing means (not shown) directs the flow of the electrolyte at the junction 17. If the conductivity has dropped below a predetermined threshold, the electrolyte is directed towards the purification system. If adequate conductivity is present, then the electrolyte flows from the tank 2 back to the electrolyser 1.

When the sensor 3 directs the electrolyte to the purification stage, it enters a first ion exchange chamber 5, which in this embodiment is a cation exchange chamber. The electrolyte flows through the first ion exchange chamber 5 to a second ion exchange chamber 6, which in this embodiment is an anion exchange chamber. The regenerated electrolyte is reintroduced to the electrolyser loop via the second ion exchange chamber's outlet stream 16.

The valves to control the flow of liquids, and computing means are not shown.

FIG. 2B differs from FIG. 2A in that it has the addition of water in its own treatment loop to create deionised water. Water is introduced via inlet 7 to softener 8 and onwards for further processing by reverse osmosis unit 9. The water then passes through a first ion exchange unit 10 and a second ion exchange unit 11. The treated water can be added to the electrolyser loop by pipe 15 and is not limited to where in the loop it is added.

FIG. 3A depicts an electrolyser loop similar to that depicted in FIGS. 2A and 2B. The difference can be seen in the purification stage 4, wherein the first ion exchange chamber 5 is provided with an inlet for the communication of a regenerating liquid 12, in this instance KCl for the cation exchange resin. Once regeneration has occurred, the regenerating liquid, the composition of which now altered, exits to waste via outlet 13a. The second ion exchange chamber 6 is provided a similar secondary inlet for the introduction of KOH 14 for the regeneration of the anion exchange resins, and disposed of via outlet 13b.

FIG. 3B differs from FIG. 3A in that the dual functionality of regenerating electrolyte and deionising water can be done by shared equipment. In this figure the earlier optional steps of softening and reverse osmosis are not shown. The water has its own inlet 7 to the cation exchange chamber 5, with a dedicated outlet for the communication of water to the second chamber 6 filled with an anion exchange resin.

Not shown are the valves and other control means adapted to ensure only water, or the electrolyte is in the ion exchange chamber 5, 6 at any given time. To allow for the dual treatment of water and electrolyte, each exchange chamber may be a stage, comprising a plurality of sub-chambers as depicted in FIG. 4A and 4B.

Not shown, but an optional feature, is a separate inlet and outlet to the cation exchange resin for the introduction and removal of an acid, notably H⁺ ions, such that the cation exchange resin can be switched between K⁺ and H⁺ for the regeneration of electrolyte and the deionisation of water. The newly conditioned resin may also be flushed once the resin has been conditioned before the regenerated electrolyte, or deionised water is used.

FIG. 4A is a closer look at the purification stage 4, including the regeneration lines 11, 12, 13a, 13b. The electrolyte is directed via inlet 20a,b,c to one of the ion exchange chambers 5a,b,c respectively. Computing means (not shown) are provided to control valves (not shown) to direct electrolyte to one ion exchange chamber 5a,b,c at a time. Regeneration liquid may be introduced to each exchange chamber by inlet 11a,b,c and removed via outlet 13a. The control system ensures regeneration is not conducted whilst electrolyte is flowing to avoid polluting the electrolyte.

The flow of electrolyte from the first stage to the second is similar to previous embodiments. A cross pipe means the outlet of exchange unit 5a does not necessarily have to go to anion exchange unit 6a.

Whilst FIG. 4B does not show the piping for the regeneration fluid, it may be present as depicted in earlier figures or in accordance with the description. This embodiment includes the water piping including inlet line 7. Much like the electrolyte shown in FIG. 4A the water can be deionised in a similar manner.

In this embodiment of the present invention the flow of water may be used to flush the regeneration liquid from each ion exchange chamber between use, with the flush water being disposed of through waste outlets 13a and b.

FIGS. 4A and 4B show the preferred embodiment with at least three ion exchange sub-chambers per stage as this would allow for deionisation of water, regeneration of electrolyte and regeneration of ion exchange resins without the need for any down time.

The present invention will now be described by reference to the following, non-limiting, examples:

### Example 1

A 1 M KOH solution is used in an AEM electrolyser. This electrolyte, like others can suffer due to carbonation when exposed to air, i.e. the solution is gradually converted to potassium carbonate and then to potassium hydrogencarbonate.

A mixed bed containing both strong cationic and strong anionic exchange resins is flushed with a 30% KOH solution, preferably having a volume of at least 2 or 3 times the resin volume. The excess KOH is washed by rinsing with deionised water. The carbonated electrolyte is regenerated by flowing it into the charged mixed bed. This results in an isotonic regeneration obtaining a KOH solution having exactly the same osmotic pressure (in this case 1 M).

### Example 2

In order to avoid handling caustic solutions, a 0.2 M sodium sulfate solution in water is used to fill an electrolyte tank. To obtain a potassium hydroxide solution in situ for use in electrolysis, a hydraulic circuit was connected to a mixed-bed resin that had been prepared similarly to that in the previous example. The sodium sulfate solution was passed through the mixed bed to obtain a 0.4 M KOH solution (i.e. an isotonic regeneration of the electrolyte). When the ion exchange is complete (e.g. as monitored by pH and/or conductivity), the electrolyte is no longer passed through the ion exchange resin and is instead diverted back to the electrolyser. When monitoring systems detect a consistent depletion of the electrolyte composition (e.g. pH decreases below 11.5 or conductivity falls below 60% of the starting value), the electrolyte is diverted back through the ion exchange resin. After regeneration of the electrolyte, the ion exchange resins are restored by flushing again with concentrated KOH solution.

The invention is not intended to be restricted to the details of the embodiments described above. For instance, any suitable ion exchange resin or equivalent may be used.

Furthermore, and as mentioned above, the present invention is not restricted to use with an electrochemical cell that is an electrolyser, but can also be used with a battery such as but not necessarily limited to a zinc-air, silver oxide or lead-acid battery.

1. A system for regenerating an electrolyte from an electrochemical cell, said system comprising:
a directing means for receiving the electrolyte from an electrochemical cell, the directing means having a first outlet and a second outlet;
a sensor or a sample port positioned between the electrochemical cell and the first outlet and the second outlet via which the presence of a contaminant in the electrolyte may be measured; and
a purification stage for receiving electrolyte from the second outlet and producing regenerated electrolyte, the purification stage comprising an ion exchange chamber;
wherein, when a contaminant is detected, the directing means directs at least a portion of the electrolyte through the second outlet to the purification stage.

2. The system according to claim 1, wherein the system comprises the electrochemical cell from which the electrolyte is regenerated.

3. The system according to claim 1, wherein the electrochemical cell comprises an electrolyser or a stack of electrolysers, wherein, when the stack of electrolysers is used, the system comprises means for combining the electrolyte streams from each of the electrolysers into a single stream upstream of the first outlet and the second outlet.

4. The system according to claim 3, wherein the electrolyser or each electrolyser of the stack of electrolysers is an anion exchange membrane (AEM) electrolyser and more preferably an APM electrolyser operating with a substantially dry cathode.

5. The system according to claim 1, wherein the sensor comprises a pH sensor, a conductivity sensor, or both.

6. The system according to claim 1, wherein the sensor is immersed in the electrolyte, or the electrolyte is intermittently sampled via the sample port.

7. The system according to claim 1, wherein the sensor or the sample port is positioned on the directing means.

8. The system according to claim 1, wherein the ion exchange chamber comprises a cation exchange resin or an anion exchange resin, wherein:
when the cation exchange resin is used, the purification stage comprises means for maintaining the temperature in the ion exchange chamber at less than 150° C.; and
when the anion exchange resin is used, the purification stage comprises means for maintaining the temperature in the ion exchange chamber at less than 80° C.; and
the ion exchange chamber optionally comprises a temperature sensor.

9. The system according to claim 1, wherein the ion exchange chamber comprises two or more sub-chambers, wherein, optionally, the two or more sub-chambers are arranged in parallel.

10. The system according to claim 1, wherein the ion exchange chamber is adapted to process each of: the electrolyte, and at least one of water and a liquid for regenerating the ion exchange chamber, wherein the ion exchange chamber preferably comprises:
a separate inlet and outlet for each of: the electrolyte, and the at least one of water and a liquid for regenerating the ion exchange chamber; or
a single inlet and outlet for each of: the electrolyte, and the at least one of water and a liquid for regenerating the ion exchange chamber;
and wherein, optionally, the ion exchange chamber comprises means that allows the flow of only one of the water or the liquid through the ion exchange chamber at any given time.

11. The system according to claim 10, wherein the system comprises at least one of a water softening stage and a reverse osmosis stage for further treating the water that passes through the ion exchange chamber.

12. The system according to claim 1, wherein the purification stage comprises a first ion exchange chamber and a second ion exchange chamber, the first ion exchange chamber comprising a cation exchange resin and the second ion exchange chamber comprising an anion exchange resin.

13. The system according to claim 12, wherein the first ion exchange chamber and the second ion exchange chamber are arranged in series such that the electrolyte passes through the first ion exchange chamber and then the second ion exchange chamber, optionally wherein a bypass mechanism allows the electrolyte to pass through only one of the first ion exchange chamber and the second ion exchange chamber.

14. The system according to claim 1, wherein the purification stage comprises a filter downstream of any ion exchange chamber.

15. The system according to claim 1, wherein at least one of the electrolyte from the at least one first outlet and the regenerated electrolyte is recycled to an electrochemical cell, and, optionally, electrochemical cell is the electrochemical cell from which the electrolyte originated.

16. The system according to claim 1, wherein the electrolyte is an aqueous solution comprising an ionic compound.

17. A method for regenerating an electrolyte from an electrochemical cell, said method comprising:
passing the electrolyte from an electrochemical cell to a directing means, the directing means having a first outlet and a second outlet;
measuring the presence of a contaminant in the electrolyte, via a sensor or sample port, between the electrochemical cell and the first outlet and the second outlet;
when a contaminant is detected, directing at least a portion of the electrolyte through the second outlet of the directing means to a purification stage; and
purifying the electrolyte from the second outlet in the purification stage to produce a regenerated electrolyte, the purification stage comprising an ion exchange chamber.

18. The system according to claim 16, wherein the ionic compound is a hydroxide salt.

19. The system according to claim 18, wherein the hydroxide salt is potassium hydroxide.
